(19) United States
(12) Patent Application Publication
(10) Pub. No.: US 2005/0083975 A1
(43) Pub. Date: Apr. 21, 2005

(54) Using multiple communication links in conjunction with a media adapter

(76) Inventor: Dean P. Macri, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/689,877

(22) Filed: Oct. 20, 2003

(51) Int. Cl. H04B 1/56

(52) U.S. Cl. 370/486

(57) ABSTRACT

A media adapter may include a wireless communication interface to receive video data from a remote program and a wired communication interface to send control data to the remote program. The media adapter may also include a display interface to direct the video data to a display device and an input interface to receive the control data for the remote program from a controller. A processor may be arranged to direct the video data to the display interface and to direct the control data to the wired communication interface.

### BACKGROUND

The claimed invention relates to media adapters and, more particularly, to communication with media adapters.

Media adapters have been proposed to communicate with a source/conduit of media information (e.g., a computer) and to connect to one or more peripheral devices for which the media information is destined. Where the media adapter is spaced apart (e.g., remote) from the source/conduit of media information, a communication link may functionally connect the media adapter and the source or conduit. The communication link may transport the media information to the media adapter and may also transport other information (e.g., media and/or control information) from the media adapter to the source/conduit of media information. The media adapter may also be considered a source of media information, for example when operating in conjunction with certain peripheral devices that generate such media information.

The communication link may have an associated bandwidth. Because sizes of media information (e.g., sound, voice, pictures, video, etc.) are typically large relative to other types of information (e.g., text, messages, etc.), it may be desirable to design the communication link with a relatively high bandwidth.

Certain applications involving media information, however, may fully utilize even relatively high bandwidths of the communication link between a media adapter and a source of the media information. Compression and/or interleaving schemes have been proposed to alleviate difficulties that occur when the communication link is highly utilized. Certain applications, however, may involve information that is sensitive to delay or latency. Such latency-sensitive information may not reach the source and/or media adapter in a timely manner over a highly utilized communication link.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. In the drawings,

FIG. 1 illustrates an example media adapter system consistent with the principles of the invention;

FIG. 2 illustrates an example device in the media adapter system of FIG. 1 according to an implementation consistent with the principles of the invention;

FIG. 3A illustrates an example process of communication over one link;

FIG. 3B illustrates an example process of communication over two links in an implementation consistent with the principles of the invention; and

FIG. 4 is a flow chart illustrating a process of handling data by a media adapter according to an implementation consistent with the principles of the invention.

### DETAILED DESCRIPTION

The following detailed description refers to the accompanying drawings. The same reference numbers may be used in different drawings to identify the same or similar elements. Also, the following detailed description illustrates certain implementations and principles, but the scope of the claimed invention is defined by the appended claims and equivalents.

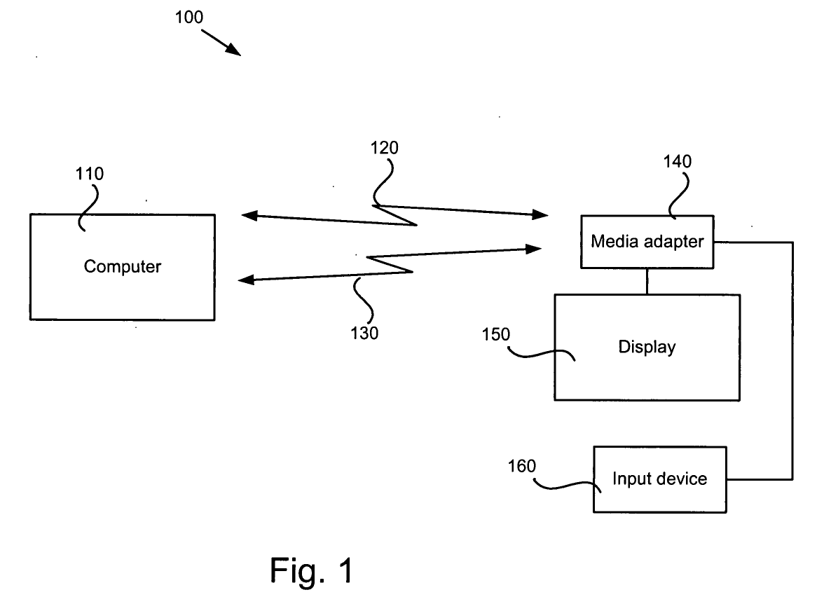

FIG. 1 illustrates an example media adapter system 100 consistent with the principles of the invention. System 100 may include a computer 110, a first communication link 120, a second communication link 130, a media adapter 140, a display 150, and an input device 160. Although the description herein will be presented in the context of a program executed by computer 110 and sending/receiving data to/from media adapter 140, it should be understood that media information transmitted over one or more of links 120/130 may originate from other than a program on computer 110. Further, in other implementations consistent with the principles of the invention, other peripherals than display 150 and input device 160 may be connected to media adapter.

Computer 110 may be arranged to execute a program and to output information to media adapter 140 via one or more of communication links 120 and 130. Computer 110 may also be arranged to receive input information from media adapter 140 via one or more of communication links 120/130. Such input information may be used by the program, and may modify the output information sent to media adapter 140. In one implementation consistent with the principles of the invention, the program executed by computer 110 may include a video game that produces a steam of video information (possibly including audio information) to be sent to media adapter 140. Other programs are possible, such as one that streams a movie (e.g., video and sound data) to media adapter 140, a telephony application, etc.

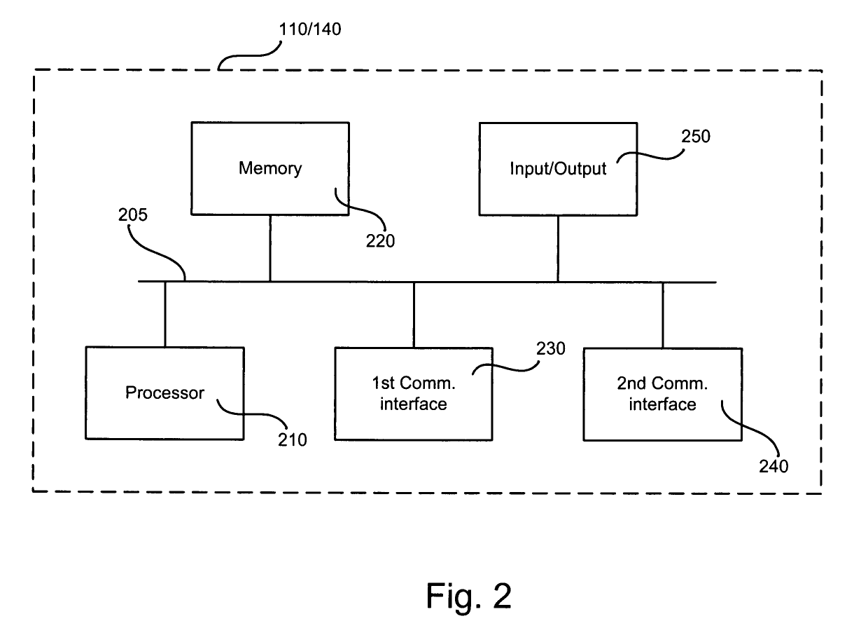

FIG. 2 illustrates an example device 110/140 in media adapter system 100 according to an implementation consistent with the principles of the invention. Both computer 110 and media adapter 140 may include some elements illustrated in FIG. 2, although each of devices 110/140 need not include all elements. Device 110/140 may include a processor 210, a memory 220, a first communication interface 230, a second communication interface 240, one or more input/output (I/O) interfaces 250, and one or more busses 205 functionally connecting elements 210-250.

Processor 210 may be arranged to execute instructions that may be part of a program. Processor 210 may also be arranged to coordinate communication and functions among the other elements 220-250. In some implementations, processor 210 in computer 110 may be relatively powerful (e.g., have a higher clock speed, more level 2 (L2) and/or level 3 (L3) cache, etc.) to effectively perform the calculations needed for an intensive program, such as a video game. Although not explicitly illustrated, in FIG. 2, processor 210 may include, at least conceptually, a dedicated graphics processor for video-intensive programs. In contrast, processor 210 in media adapter 140 may be less powerful in accordance with the somewhat less demanding functions of directing media information to or from its one or more peripheral devices.

Processor 210 may, in some implementations, include multiple cores. In certain implementations consistent with the principles of the invention, processor 210 may be able to execute more than one task concurrently. Such ability may facilitate the handing of relatively large amounts of data.

Memory 220 may be arranged to store instructions and/or programs for execution by processor 210, as well as data products of the instructions and/or programs. Memory 220 may include random access memory (RAM), read only memory (ROM), flash memory, and may include other types of storage media, such as magnetic hard drives and optical media (e.g., compact discs (CDs), digital versatile discs (DVDs), etc.) and their associated optical drives.

First communication interface 230 may be arranged to transmit and receive data via first communication link 120, and second communication interface 240 may be arranged to transmit and receive data via second communication link 130. Communication interfaces 230/240 may be arranged to facilitate communication via their associated communication link 120/130. For example, if first communication link 120 is a wireless link, first communication interface 230 may include circuitry and optionally an antenna arranged to send and receive wireless signals. Conversely, if first communication link 120 is a wired link (including wires or other physical conduits such as optical fibers), first communication interface 230 may include circuitry and a connector arranged to send and receive signals via a wire, cable, fiber, or the like.

Input/Output (I/O) interface 250 may include circuitry and connectors to interface with one or more peripheral input and/or output devices. For example, I/O interface 250 in media adapter 140 may include suitable connections to display 150 and to input device 160.

Returning to FIG. 1, first communication link 120 may include a wireless or wired (e.g., electrically or optically conductive transport media) link between computer 110 and media adapter 140. First communication link 120 may be used primarily for transporting media information (e.g., video and/or audio data) from computer 110 to media adapter 140. First communication link 120 may have a relatively high bandwidth, such as an IEEE 802.11 a link, an IEEE 802.11b link, an EEE 802.11g link, or similar wireless links. If first communication link 120 is a wired link, for example, a high speed Ethernet link, an IEEE 1394a or 1394b link, a synchronous optical network (SONET) link, or similar wired link may be used.

Second communication link 130 may include another wireless or wired link between computer 110 and media adapter 140 that is distinct from first communication link 120. Second communication link 130 may be used primarily for transporting latency-sensitive information from media adapter 140 to computer 100, as will be elaborated in further detail herein. Second communication link 130 may have a relatively low bandwidth, depending on the size of the latency-sensitive information from media adapter 140. If second communication link 130 is a wireless link, for example, a Bluetooth®-compliant link or similar wireless link may be used. If second communication link 130 is a wired link, for example, an AC power line-based communication link, a twisted pair of wires, a universal serial bus (USB) cable, or similar wired link may be used. Although first communication link 120 and second communication link 130 have been described as having certain bandwidths, such links may employ any of the above-mentioned wireless and/or wired links or similar links to those mentioned, as long as second communication link 130 is distinct from first communication link 120 and capable of delivering data with a relatively low latency or delay.

Media adapter 140 may include one or more of elements 210-250 as described with regard to FIG. 2. Media adapter 140 may be arranged to communicate via first and second communication links 120 and 130 and to interface with display 150 and input device 160. In one implementation consistent with the principles of the invention, media adapter 140 may be arranged to receive video data via first communication link 120, decode the video data if necessary for display, and direct such (decoded) data to display 160. Media adapter may also be arranged to receive input data from input device 160, decode the input data if necessary for transmittal, and transmit the input data to computer 110 via second communication link 130. Although not explicitly illustrated in FIGS. 1 and 2, media adapter may also be arranged to connect to one or more of a number of video input sources (e.g., coaxial cable, an antenna, a satellite signal), a telephony or other communication network, a remote control, a storage device, a sound output device (e.g., stereo tuner, speakers, headphones), and/or a recording device.

Media adapter 140 may be located remote from computer 110. In some implementations, computer 110 and media adapter 140 may be located within the same room of a building, but spaced apart. In other implementations consistent with the principles of the invention, media adapter 140 may be located in a different room (e.g., den or other entertainment-oriented room) from the room in which computer 110 is located (e.g., office or other non-entertainment-oriented room).

Display 150 may include a television, monitor, projector, or other device suitable for displaying media information, such as video and audio. Display 150 may utilize a number of technologies for such displaying, including cathode ray tube (CRT), liquid crystal display (LCD), plasma, and/or projection-type technologies. Display 150 may be located proximate media adapter 140, which may in some implementations sit on top of or adjacent to display 150.

Input device 160 may be connected to media adapter 140 to supply input to a program on computer 110 via second communication link 130. Input device 160 may include, for example, a game controller or similar device. Although termed an “input” device, device 160 may perform both I/O functions, because some devices may include force feedback schemes or other mechanisms to output information to a user of the device. Although shown directly connected to media adapter 140 in FIG. 2, input device 160 may, in some implementations, be functionally connected to media adapter 140 via an intermediate device, such as display 150.

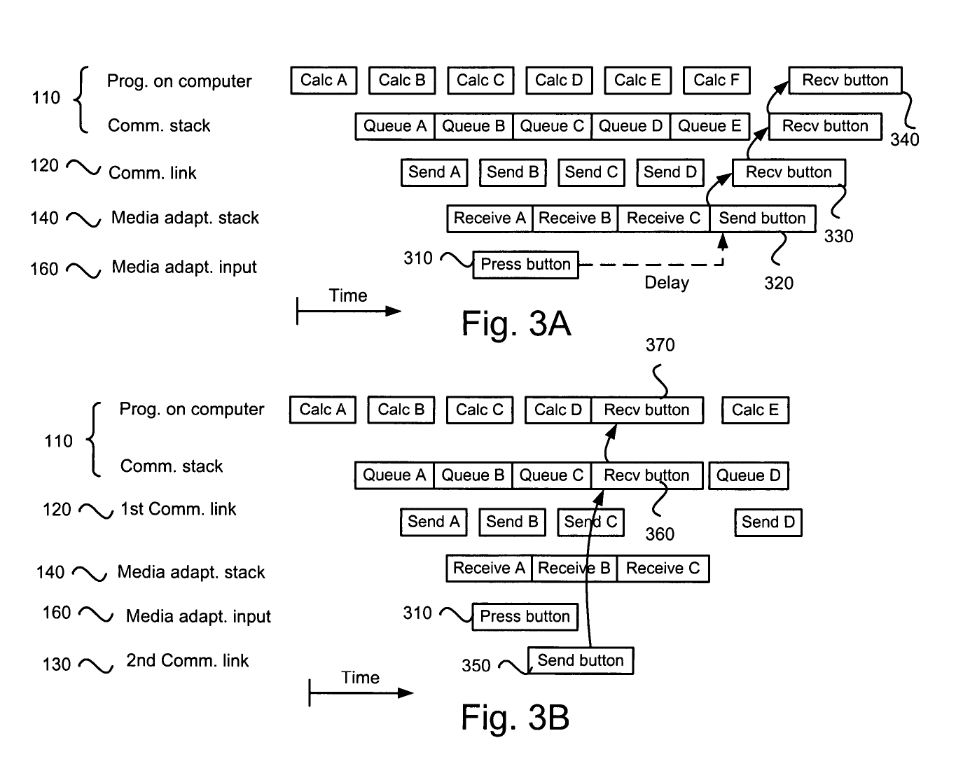

FIG. 3A illustrates an example process of communication over first communication link 120. For the purposes of illustration and explanation, the process in FIG. 3A assumes that only a single communication link 120 is present between computer 110 and media adapter 140. In FIG. 3A, a number of events are shown in time that are associated with a number of elements of FIGS. 1 and 2.

The top row in FIG. 3A illustrates calculations that may be performed, for example, by processor 210 in computer 110. The next row illustrates data from processor 210 and link 120 that may be stored in, for example, a stack in a memory 220 of computer 110. The middle row illustrates data transmitted over communication link 120 in time. The next row illustrates data from input device 160 and link 120 that may be stored in, for example, a stack in a memory 220 in media adapter 140. The bottom row illustrates data output to media adapter 140 by input device 160.

As illustrated in FIG. 3A, computer 110 may perform a number of calculations, Calc A, Calc B. etc., in accordance with executing a program (e.g., a video game or other application), and may store corresponding video information (e.g., Queue A, Queue B, etc.) in its communication stack. When bandwidth is available, this information may be transmitted to media center 140 on communication link 120 as Send A, Send B, etc. Media adapter 140 may store the received video information, Receive A, Receive B, etc., in a stack while sending this information to display 150 and/or receiving information from link 120.

At 310, a user may press a button or perform some other action on input device 160. Because of the video information already present in the stack of media adapter 140, there may be some delay before media adapter 140 can send the button press event at 320. Depending on existing utilization of communication link 120, there may be further delay before the button press is transmitted to computer 110 at 330. The program on computer 110 may not receive the button press event until 340, significantly after 310 when input device 160 was actuated.

FIG. 3B illustrates an example process of communication between computer 110 and media adapter 140 over two communication links 120 and 130 in an implementation consistent with the principles of the invention. The first five rows of FIG. 3B are similar to those described above in FIG. 3A. In addition, the bottom row of FIG. 3B illustrates data transmitted over second communication link 130 in time.

As illustrated in FIG. 3B, at the same time 310 as in FIG. 3A, a user may press a button or perform some other action on input device 160. Instead of queuing this button press event in the communication stack for first communication link 120, media adapter 140 may immediately send the button press event to computer 110 over second communication link 130 at 350. The delay/latency of such transmission may be minimized if second communication link 130 is not utilized at the time of such transmission. Overall latency may still be reduced relative to the single-link scheme in FIG. 3, however, if second communication link 130 has a lower latency than first communication link 120.

Computer 110 may receive the button press event on second communication link 130 and may insert it into the communication stack at 360. Processor 210 in computer 110 may incorporate the button press event into its executing program at 370, before performing Calc E. The button press event in FIG. 3B is acted upon by computer 110 earlier than in FIG. 3A. Although only illustrated as being before two calculations, Calc E & F, this is purely exemplary, and the scheme in FIG. 3B may in practice avoid a delay of many more than two calculations. Thus, the visual feedback presented to the user of input device 160 via display 150 may appear more responsive due to the use of the lower-latency second communication link 130.

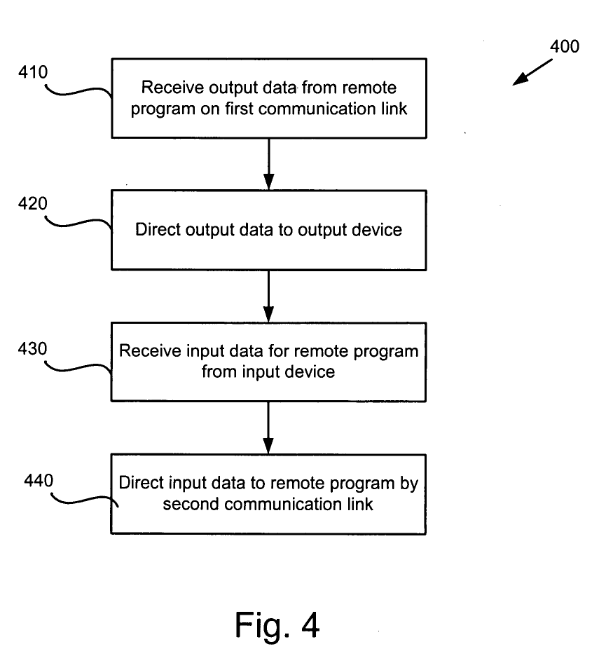

FIG. 4 is a flow chart illustrating a process 400 of handling data by media adapter 140 according to an implementation consistent with the principles of the invention. Processing may begin by receiving output data from a remote program over first communication link 120 [act 410]. This output data may include, for example, video and/or audio data output by the remote program. As previously explained, the remote program may execute on computer 110.

The output data may be directed to an output device [act 420]. If necessary, media adapter 140 may decode or otherwise further process the output data before directing it to the output device. For example, if video and/or audio data is output by the remote program, this may be decoded before sending it to display 150.

Processing may continue by receiving input data for the remote program from input device 160 [act 430]. It should be noted that act 430 may occur concurrently with act 410 or act 420. Such input data may include relatively low-bandwidth, low latency data, such as a button press event. Other input data with different characteristics, however, may be generated by other types of input devices.

Media adapter 140 may direct the input data from input device 160 to the remote program via second communication link 130 [act 440]. It should be noted that act 440 also may occur concurrently with act 410 or act 420. Hence, for input data that should have a low latency before reaching the remote program, act 440 permits the sending of such input data without having to wait for breaks in arriving output data in act 410.

The foregoing description of one or more implementations consistent with the principles of the invention provides illustration and description, but is not intended to be exhaustive or to limit the claimed invention to the precise form disclosed. Modifications and variations are possible in light of the above teachings or may be acquired from practice of the invention.

For example, although first communication link 120 has been described as having a higher bandwidth than second communication link 130, this need not always hold. Consistent with the principles of the invention, first communication link 120 and second communication link 130 may have different bandwidth, latency and/or reliability characteristics to address different aspects of playback on media adapter 140 from a remote program. Although achieving low latency for an input to the remote program has been explained above, multiple communication links may be used to facilitate other aspects of playback on media adapter 140 from a remote program. Alternately or additionally, communication links 120/130 may have substantially the same characteristics but may be used differently to address different aspects of communication between media adapter 140 and a remote program.

Further, although computer 110 has been described in the context of a general-purpose device, it may also include a specific-purpose device such as a game console. Such game consoles may include any now-known or later-developed game-capable device and/or their portable variants. Also, although communication links 120/130 may have been implied as being unitary, in some implementations each of links 120/130 may include more than one sub-link (e.g., connected serially) to form the links 120/130 described herein.

Also, although FIG. 1 illustrates two communication links 120/130, three or more communication links may exist between computer 110 and media adapter 140. For example, in a telephony or two-way video application, two (possibly wireless) links may be present to handle the two-way communication data, and a third link may carry control or other related data.

Moreover, the acts in FIG. 4 need not be implemented in the order shown; nor do all of the acts necessarily need to be performed. Also, those acts that are not dependent on other acts may be performed in parallel with the other acts. Further, the acts in this figure may be implemented as instructions, or groups of instructions, implemented in a computer-readable medium.

No element, act, or instruction used in the description of the present application should be construed as critical or essential to the invention. Also, as used herein, the article “a” is intended to include one or more items. Where only one item is intended, the term “one” or similar language is used. Variations and modifications may be made to the above-described implementation(s) of the claimed invention without departing substantially from the spirit and principles of the invention. All such modifications and variations are intended to be included herein within the scope of this disclosure and protected by the following claims.

1. A method, comprising:
receiving video information from a remote program over a first communication link;
directing the video information to a display device;
receiving input information from an input device; and
sending the input information to the remote program over a second communication link that is different than the first communication link.

2. The method of claim 1, further comprising:
decoding the video information before the directing.

3. The method of claim 1, wherein the sending the input information over a second communication link is performed concurrently with the receiving video information over a first communication link.

4. The method of claim 1, wherein the first communication link has a higher associated bandwidth than the second communication link.

5. The method of claim 1, wherein the second communication link has a lower associated latency than the first communication link.

6. The method of claim 1, wherein the first communication link includes a wireless link, and
wherein the second communication link includes a wired link that operates over alternating current-carrying lines.

7. The method of claim 1, wherein the remote program includes a video game or video display application executed on a remote computing device.

8. An apparatus, comprising:
a first communication interface to receive output data from a remote program;
a second communication interface to send input data to the remote program;
an output interface to direct the output data to an output device;
an input interface to receive the input data from an input device; and
a processor arranged to direct the output data to the output interface and to direct the input data to the second communication interface.

9. The apparatus of claim 8, wherein the first communication interface is arranged to communicate via a wireless link.

10. The apparatus of claim 9, wherein the second communication interface is arranged to communicate via a wireless link.

11. The apparatus of claim 9, wherein the second communication interface is arranged to communicate via a wired link.

12. The apparatus of claim 8, wherein the first communication interface is arranged to communicate via a wired link.

13. The apparatus of claim 12, wherein the second communication interface is arranged to communicate via a wired link.

14. The apparatus of claim 12, wherein the second communication interface is arranged to communicate via a wired link.

15. The apparatus of claim 8, wherein the output interface is arranged to direct the output data to a display, and
wherein the input interface is arranged to receive the input data from a game controller.

16. A machine readable medium having instructions stored thereon, the instructions comprising:
instructions for receiving high-bandwidth information from a remote program over a first communication link;
instructions for directing the high-bandwidth information to a display device;
instructions for receiving low-bandwidth information from an input device; and
instructions for sending the low-bandwidth information to the remote program over a second communication link that has a lower associated latency than the first communication link.

17. The machine readable medium of claim 16, further comprising:
instructions for decoding the high-bandwidth information prior to sending it to the display device.

18. The machine readable medium of claim 16, wherein the high-bandwidth information is video information, and
wherein the low-bandwidth information is control information.

19. The machine readable medium of claim 16, wherein the remote program is a video game or a video player program.

20. The machine readable medium of claim 16, wherein the first communication link is a wireless communication link, and
wherein the second communication link is a wired communication link.

21. A media adapter, comprising:
a wireless communication interface to receive video data from a remote program;
a wired communication interface to send control data to the remote program;
a display interface to direct the video data to a display device;
an input interface to receive the control data for the remote program from a controller; and
a processor arranged to direct the video data to the display interface and to direct the control data to the wired communication interface.

22. The media adapter of claim 21, wherein processor is further arranged to direct the control data to the wired communication interface while directing the video data to the display device.

23. The media adapter of claim 21, wherein processor is further arranged to decode the video data before directing it to the display device.

24. The media adapter of claim 21, wherein processor is further arranged to encode the control data before directing it to the wired communication interface.

25. The media adapter of claim 21, further comprising:
another wireless communication interface to send video data to the remote program.
